(19) United States
(12) Patent Application Publication
(10) Pub. No.: US 2013/0056315 A1
(43) Pub. Date: Mar. 7, 2013

(54) METHOD FOR SETTING THE CLAMPING FORCE EXERTED BY A PARKING BRAKE IN A VEHICLE

(71) Applicants: Karsten BIELTZ, Mudelsheim (DE); Simon HAUBER, Freiberg Am Neckar (DE)

(72) Inventors: Karsten BIELTZ, Mudelsheim (DE); Simon HAUBER, Freiberg Am Neckar (DE)

(73) Assignee: Robert Bosch GmbH, Stuttgart (DE)

(21) Appl. No.: 13/404,130

(22) Filed: Feb. 24, 2012

(30) Foreign Application Priority Data
Feb. 25, 2011 (DE) 102011004786.7

(51) Int. Cl. B60T 7/00; B60T 1/06

(52) U.S. Cl. 188/106 P

(57) ABSTRACT

In a method for setting the clamping force exerted by a parking brake, for the case in which after the conclusion of a clamping process an event occurs that disturbs the stationary situation of the vehicle, a subsequent clamping process is carried out by actuating an electric brake motor and an additional brake device.

### CROSS REFERENCE

The present application claims the benefit under 35 U.S.C. §119 of German Patent Application No. DE 102011004786.7 filed on Feb. 25, 2011, which is expressly incorporated herein by reference in its entirety.

### FIELD OF THE INVENTION

The present invention relates to a method for setting the clamping force exerted by a parking brake in a vehicle.

### BACKGROUND INFORMATION

German Patent No. DE 103 61 042 33 describes a vehicle parking brake capable of producing a clamping force that holds the vehicle at a standstill. The parking brake has an electromechanical construction and has an electric brake motor that displaces a brake piston, bearing a brake lining, axially in the direction toward a brake disk in order to achieve a desired clamping force.

Moreover, conventionally, the hydraulic pressure generated in a hydraulic vehicle brake is used to support the clamping force, the hydraulic pressure also acting on the brake piston and displacing this piston against the brake disk, so that the clamping force as a whole is composed of an electromotoric component and a hydraulic component.

### SUMMARY

An object of the present invention is to increase security against unintended movements of a vehicle after a parking brake has been actuated.

An example method according to the present invention relates to an electromechanical parking brake in a vehicle having an electric brake motor capable of producing a clamping force upon actuation. The rotational movement of the rotor of the brake motor is transformed into an axial actuating movement of a brake piston bearing a brake lining that is pressed against a brake disk.

The parking brake is provided with an additional brake device capable of producing an additional clamping force, in addition to or alternatively to the electromotoric brake device. The additional brake device is capable of being controlled separately from, or independently of, the electromechanical brake device. The additional brake device is in particular a hydraulic brake device, preferably the regular vehicle brake in the vehicle, the hydraulic pressure acting on the brake piston, which is thus acted on by both the braking devices when there is simultaneous actuation of the electromechanical brake device and the hydraulic brake device.

According to an example embodiment of the present invention, in the event that after conclusion of a clamping process, an event occurs that interferes with the immobilization of the vehicle, it is provided that a subsequent clamping process is carried out in order to increase the clamping force or to ensure a nominal clamping force. The subsequent clamping process is carried out by actuating both the electric brake motor, which is a part of the electromechanical brake device, and the additional brake device. Thus, if the additional brake device is realized as a hydraulic brake device, during the subsequent clamping process the electric brake motor is actuated in order to increase the electromechanical clamping force, and at the same time a hydraulic pressure is produced in the hydraulic vehicle brake that sets a hydraulic clamping force component.

In this procedure, in the event of interference with or danger to the immobilization of the vehicle, not only the electromechanical brake device but in addition the additional brake device is actuated, so that the setting of the clamping force is divided between two different actuators. In this way, the security against unintentional rolling away of the vehicle is increased. In addition, the dynamic behavior of the subsequent clamping process is improved in relation to embodiments in which only one actuator is active. The noise level during the subsequent clamping process is also lower, because the actuators, considered in themselves, are operated with a lower dynamic than in the case of only a single actuator activated during the subsequent clamping process. In the example method according to the present invention there therefore takes place a superposition of the clamping force produced by the electromechanical clamping force and by the additional brake device.

If warranted, a rotational speed sensor in the electric brake motor can be omitted.

After the conclusion of the subsequent clamping process, the electric brake motor is switched off, whereupon the overall clamping force prevailing at the time of the switching off, which is composed of the electromechanical component and the additional brake device component, is frozen or preserved.

According to a useful example embodiment, it is provided that during the subsequent clamping process, in order to achieve a desired nominal clamping force the electromotoric brake device is primarily actuated, and the additional brake device is actuated only in supplemental fashion. However, it is preferred that a minimum clamping force be produced in the additional brake device during the subsequent clamping process in order to ensure that the additional brake device sets a minimum component of the overall clamping force. In the embodiment of the additional brake device as a hydraulic brake device, a minimum pressure is thus present during the subsequent clamping process. The additional clamping force exerted via the additional brake device can however also be modulated in order to provide as needed a component higher than the minimum clamping force.

An unintended movement of the vehicle can be used as a trigger condition for the subsequent clamping process. If the currently acting clamping force in the parking brake is not sufficient to hold the vehicle stationary, the movement of the vehicle can be detected by the vehicle's onboard sensor system, and the subsequent clamping process can be triggered in the parking brake. This relates to situations in which the vehicle goes into motion without external action, in particular without driver actuation. This may also relate to driving situations in which the driver seeks, by actuating the vehicle engine, to set the vehicle into motion.

A disturbance in the brake system of the parking brake may also be used as a further triggering criterion, for example if the brake disk temperature is above an assigned threshold value. The concomitant reduction in the clamping force can be compensated by the subsequent clamping process. The subsequent clamping process is carried out in particular only after the expiration of a defined period of time—the cooling-off time.

The subsequent clamping process is terminated when a switch-off criterion has been reached. The traveling of a defined distance by the actuating element actuated by the electric brake motor or the rotor of the brake motor may for example be used as a switch-off criterion. The distance traveled by the actuating element, in particular a spindle driven by the brake motor, is designed as a minimum path to which a minimum clamping force is allocated. For the determination of the distance, a sensor-based or model-based path signal is required.

In addition, or alternatively, the overall clamping force, composed of the electromechanical clamping force and the clamping force of the additional brake device, can also be used as a switch-off criterion. If the overall clamping force exceeds an allocated threshold value, the electric brake motor is switched off. The electromechanical clamping force is usefully determined on the basis of a model in which for example the current characteristic of the electric brake motor is used as measurement signals. In the case of an embodiment of the additional brake device as a hydraulic brake device, the hydraulic pressure is measured or is determined on the basis of a model, and the hydraulic brake force component can be calculated from this hydraulic pressure.

The example method according to the present invention is executed in a regulating or control device in the vehicle that can be a component of the parking brake system.

Further advantages and useful embodiments are found in the description of the Figures, and the Figures.

### BRIEF DESCRIPTION OF THE DRAWINGS

FIG. 1 shows a section through an electromechanical parking brake for a vehicle in which the clamping force is produced by an electric brake motor.

FIG. 2 shows a diagram with curves for current, voltage, and rotational speed of the electric brake motor, the hydraulic pressure, and the overall clamping force during a subsequent clamping process.

### DETAILED DESCRIPTION OF EXAMPLE EMBODIMENTS

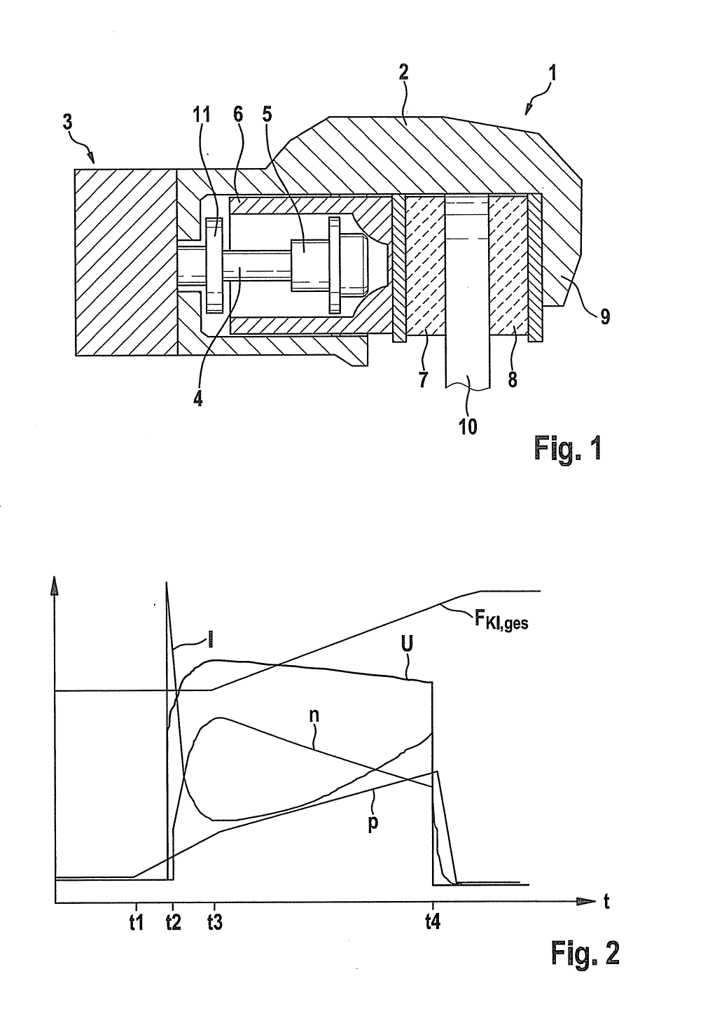

FIG. 1 shows an electromechanical parking brake 1 for holding a vehicle at a standstill. Parking brake 1 has a brake caliper 2 having a binding piece 9 that overlaps a brake disk 10. As an actuating element, parking brake 1 has an electric motor as brake motor 3 that rotationally drives a spindle 4 on which a spindle component 5 is rotatably mounted. When there is rotation of spindle 4, spindle component 5 is axially displaced. Spindle component 5 moves inside a brake piston 6, bearing a brake lining 7, that is pressed against brake disk 10 by brake piston 6. On the opposite side of brake disk 10 there is situated a further brake lining 8 that is held stationary on binding piece 9.

Inside brake piston 6, spindle component 5 can move axially forward in the direction toward brake disk 10 when there is a rotational movement of spindle 4, or, when there is a rotational movement of spindle 4 in the opposite direction, spindle component 5 can move axially backward until it reaches a stop 11. In order to produce a clamping force, spindle component 5 acts on the inner end surface of brake piston 6, causing brake piston 6, mounted displaceably in parking brake 1, to be pressed with brake lining 7 against the facing end surface of brake disk 10.

If necessary, the parking brake can be supported by a hydraulic vehicle brake so that the clamping force is composed of an electromotoric component and a hydraulic component. When there is hydraulic support, the rear side, facing the brake motor, of brake piston 6 is acted on by hydraulic fluid under pressure.

FIG. 2 is a diagram showing the curves for current I, voltage U, and rotational speed n of the electric brake motor for a subsequent clamping process, and moreover showing hydraulic pressure p of the hydraulic brake device and the overall clamping force F_{kl,ges}, composed additively of an electromotoric component and a hydraulic component. The curve is shown as a function of time. At time t₁, the subsequent clamping process begins in the parking brake. This is triggered by the determination of a disturbing event, for example an unintended movement of the vehicle, or a brake disk temperature above an assigned threshold value. At time t₁, pressure p in the hydraulic brake device first increases. This is intended to ensure a minimum pressure in the hydraulic brake device during the subsequent clamping process.

At time t₂ the electric brake motor is started and is displaced in the direction of an increased clamping force. The switching-on process coincides with a peak of current curve I that subsequently falls off again and then continuously increases until time t₄. Due to play in the transmission, the electric brake motor starts up at first without load.

At time t₃ a buildup of clamping force takes place. In the electric brake motor, the play in the transmission inherent to the system is overcome, so that the brake piston moves forward. This forward movement is supported by hydraulic pressure p, so that a combined buildup of force takes place, composed of the electromechanical component and the hydraulic component. Due to a mutual influence, a bend can be seen in the pressure curve, resulting from an increasing volume due to the forward movement of the brake piston. At the same time, current curve I runs flatter, because the electric brake motor is relieved of load by the hydraulic brake device.

At time t₄, the nominal clamping force level is reached, the electric brake motor is switched off, and the clamping force level that has been reached is preserved. The slight increase in the clamping force level going past switch-off time t₄ is due to the dynamic behavior of the brake system.

The bend in the pressure curve seen at time t₃, with a subsequent slight increase in the pressure, is an indication that the pressure set in the brake system is effective and is supplying a hydraulic clamping force component. The bend in the pressure curve can thus be used as an additional plausibilization.

The switching off at time t₄ is carried out when a switch-off criterion is reached, usefully combining two different criteria. On the one hand, the path traveled by the electric brake motor, or by the actuating element displaced by the brake motor, namely the spindle or the brake piston, is used as a switch-off criterion. If the path traveled exceeds a threshold value, the brake motor is switched off. On the other hand, the reaching of a desired target clamping force by the combination of electromechanical clamping force and hydraulic clamping force can be used as a switch-off criterion. If the sum of the electromechanical and hydraulic clamping force, taking into account a tolerance, has reached the target clamping force, the switching off of the electric brake motor likewise takes place.

What is claimed is:

1. A method for setting in a vehicle a clamping force exerted by a parking brake, produced at least partly by an electromotoric brake device having an electric brake motor and an additional brake device, the method comprising:
carrying out a subsequent clamping process by actuating both the electric brake motor and the additional brake device in the event that after conclusion of a first clamping process, an event occurs that interferes with immobilization of the vehicle.

2. The method as recited in claim 1, wherein during the subsequent clamping process, to achieve a desired clamping force the electromotoric brake device is primarily actuated, and the additional brake device is actuated as a supplement.

3. The method as recited in claim 1, wherein during the subsequent clamping process, a defined minimum clamping force is produced in the additional brake device.

4. The method as recited in claim 1, wherein the subsequent clamping device is carried out when the vehicle is set into motion.

5. The method as recited in claim 1, wherein the subsequent clamping process is carried out when a temperature of a brake disk exceeds a threshold value.

6. The method as recited in claim 1, wherein the subsequent clamping process is terminated when an actuating element actuated by the electric brake motor has traveled a defined distance.

7. The method as recited in claim 1, wherein the subsequent clamping process is terminated when an overall clamping force the additional brake device exceeds an assigned threshold value.

8. The method as recited in claim 1, wherein the additional brake device is a hydraulic brake device.

9. A regulating or control device for setting a clamping force exerted by a parking brake produced at least partly by an electromotoric brake device having an electric brake motor and an additional brake device, the device configured to carry out a subsequent clamping process in the event that after conclusion of a first clamping process, an event occurs that interferes with immobilization of the vehicle.

10. A parking brake in a vehicle having a regulating or control device, the device for setting a clamping force exerted by a parking brake produced at least partly by an electromotoric brake device having an electric brake motor and an additional brake device, the device configured to carry out a subsequent clamping process in the event that after conclusion of a first clamping process, an event occurs that interfaces with immobilization of the vehicle.
